(19) United States
(12) Patent Application Publication
(10) Pub. No.: US 2025/0042782 A1
(43) Pub. Date: Feb. 6, 2025

(54) RAPID AND EFFICIENT PFAS EXTRACTION BY BIOCOMPATIBLE POLYMER COACERVATE ADSORBENTS FOR WATER TREATMENT

(71) Applicant: Wayne State University, Detroit, MI (US)

(72) Inventors: Yingxi Elaine Zhu, Troy, MI (US); Ali Hatami, Detroit, MI (US)

(21) Appl. No.: 18/793,055

(22) Filed: Aug. 2, 2024

Related U.S. Application Data
(60) Provisional application No. 63/530,794, filed on Aug. 4, 2023.

(51) Int. Cl. C02F 1/52; B01J 20/26; C02F 101/36

(52) U.S. Cl. CPC C02F 1/5272; B01J 20/262; C02F 2101/36

(57) ABSTRACT

A method of removing per- and polyfluoroalkyl substances (PFAS) from water includes adding a polymer coacervate adsorbent including oppositely charged polyelectrolytes to contaminated water. The two oppositely charged polyelectrolytes are biocompatible. An adsorbent for removal of per- and polyfluoroalkyl substances (PFAS) from contaminated water includes oppositely charged polyelectrolytes. The polyelectrolytes include polyacrylic acid (PAA) and/or polyethylene oxide (PEO) according to an example.

### CROSS-REFERENCE TO RELATED APPLICATIONS

This application claims priority to U.S. Prov. App. No. 63/530,794 filed on Aug. 4, 2023, the contents of which are hereby incorporated by reference in their entirety.

### TECHNICAL FIELD

Exemplary fields of technology for the present disclosure relate to removal of polyfluoroalkyl substances (PFAS) from contaminated water, particularly to rapid and efficient PFAS extraction by biocompatible coacervate adsorbents for water treatment.

### BACKGROUND

Per- and polyfluoroalkyl substances (PFAS) have been widely used in various industries and products, which has led to the pervasive presence of PFAS in the environment, including drinkable water. Many PFAS such as perfluorooctanoic acid (PFOA) and perfluorooctanesulfonic acid (PFOS) pose health and environmental concerns because they are persistent organic pollutants or “forever chemicals”. The legal limit in the United States for PFOA and PFOS in drinking water is 4 parts per trillion (ppt), while some lesser studied compounds such as perfluorononanoic (PFNA) and hexafluoropropylene oxide dimer acid (HFPO-DA) have a threshold of 10 ppt.

Various treatment methods have been proposed for removing PFAS contamination from the environment. These technologies may be applied to drinking water sources, groundwater, wastewater, surface water, and other aqueous solutions. Among the technologies, adsorbents have shown promise with activated carbon garnering much attention due to its cost-effectiveness and safety. Unfortunately, existing technologies have limitations including extraction capacity and efficiency.

Therefore, a need exists for an improved water-treatment adsorbent.

### SUMMARY

The disclosure provides a unique type of polymer coacervate adsorbent using two oppositely charged polyelectrolytes for treating contaminated water, e.g., for removing PFAS and/or biological toxins.

Pursuant to a first aspect, there is disclosed an adsorbent for removal of per- and polyfluoroalkyl substances (PFAS) from contaminated water. The adsorbent includes a polymer coacervate material including oppositely charged polyelectrolytes.

Pursuant to a second aspect, there is disclosed a method for removing PFAS from water including adding a polymer coacervate adsorbent comprising oppositely charged polyelectrolytes to contaminated water.

According to a third aspect, there is disclosed a polymer coacervate composition for treating contaminated water including two oppositely charged biocompatible polyelectrolytes.

The disclosed polymer coacervate adsorbent achieves commercial demands of efficient, environmentally-friendly, and cheap materials to remove PFAS and/or biological toxins from water (e.g., wastewater, contaminated drinking water, groundwater, surface water, etc.). The disclosed polymer coacervate adsorbent has demonstrated a removal efficiency of PFAS from water of about 99% or below about 4-10 ppt.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description. Exemplary illustrations are described in detail by referring to the drawings as follows.

FIG. 1 shows a scheme for the synthesis of an exemplary polymer coacervate adsorbent; and

FIG. 2 is a graph of the concentration of PFOA (ng/l or ppt) following extraction with various samples of exemplary polymer coacervates according to the disclosure.

### DETAILED DESCRIPTION

The disclosure is a novel type of polymer coacervate adsorbent using two oppositely charged polyelectrolytes for the rapid and efficient removal of per- and polyfluoroalkyl substances (PFAS) from contaminated water. Further disclosed is a process for removing PFOA and/or biotoxins from water using a polymer coacervate adsorbent including two oppositely charged polyelectrolytes. In one example the two oppositely charged polyelectrolytes are biocompatible. Polyelectrolytes, in one example, are polymers whose repeating units bear an electrolyte group. Polycations and polyanions are polyelectrolytes, and these groups dissociate in aqueous solutions, making the polymers charged. As such, the oppositely charged polyelectrolytes are added to an aqueous solution (e.g., contaminated water) for adsorption of PFAS, where the polyelectrolytes bond or otherwise stick to the surface of the contaminants (e.g., PFAS), so that extraction of PFAS occurs spontaneously in water and the supernatant is the treated water.

The polyelectrolytes may include, but are not limited to, polyacrylic acid (PAA) and/or polyethylene oxide (PEO). The PAA may include, but not be limited to, a PAA powder with a molecular weight (Mw) of 400,000 (PAA₄₀₀ₖ) or 450,000 (PAA₄₅₀ₖ) or 4,000,000 (PAA₄₀₀₀ₖ). Additionally or alternatively, the PEO may include, but not be limited to, PEO powder with a Mw of 100,000 (PEO₁₀₀ₖ). The PAA and the PEO may be provided in a concentration ratio of about 1 (PAA) to 10 (PEO), e.g., a concentration ratio of about 0.1 mM of PAA and about 1 mM of PEO. According to another example, the PAA and the PEO may be provided in a concentration ratio of about 0.0025 mM of PAA and 1 mM of PEO.

It will be appreciated that other oppositely charged and biocompatible polymers of varied molecular weight and mixing concentration ratios may be selected without departing from the scope of the disclosure. Examples of polycations in addition to PEO include, but are not limited to, polyethyleneimine (PEI), polyallylamine hydrochloride (PAH), polydimethyldiallylammonium chloride (PDDA). Examples of polyanions in addition to PAA include, but are not limited to, polystyrene sulfonate (PSS) and polyvinyl sulfate (PVS).

Pursuant to an implementation, the PAA is chemically linked with PEO to form a polymer coacervate (e.g., PAA is covalently bonded or polymerized with PEO). For example, 0.1 mM of PAA and 1 mM of PEO may be mixed together in deionized water to form a PEO-PAA polymer coacervate adsorbent. The PEO-PAA polymer coacervate adsorbent may be formed as a powder or a polymer separation membrane (e.g., a microporous polymer adsorptive layer(s)).

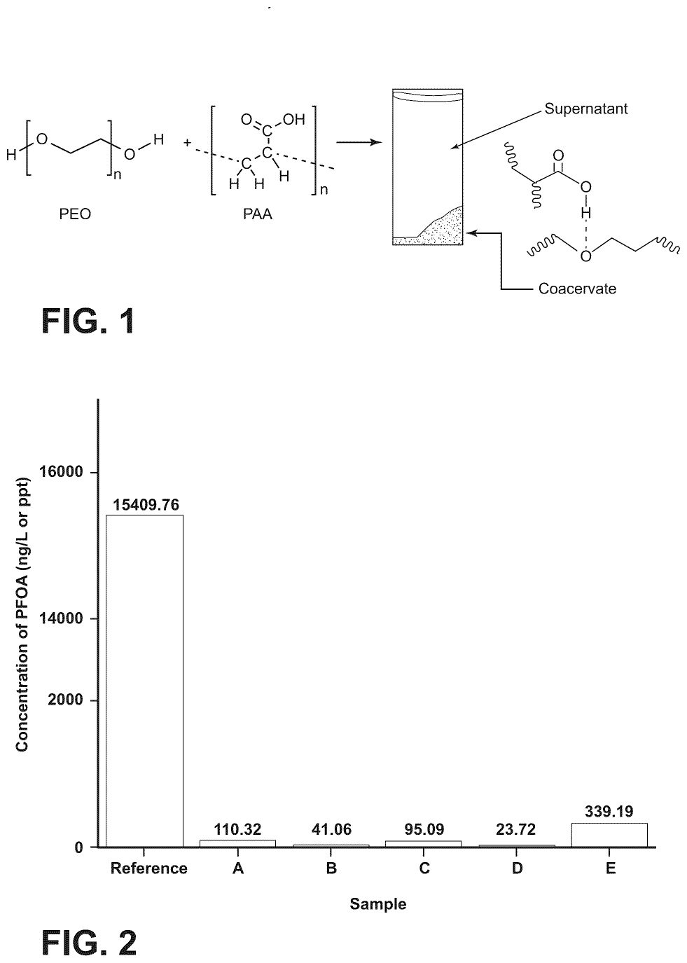

Referring to FIG. 1, a scheme for the synthesis of an exemplary polyelectrolyte coacervate is shown. The polymer coacervate adsorbent in the illustrated example includes polyelectrolytes in the form of PEO and PAA, wherein n represents the number of repeating units. The PEO-PAA coacervate may be formed by mixing a given molar or weight ratio of PEO and PAA in an aqueous solution (e.g., deionized water) to link or polymerize the PEO with PAA (e.g., PEO bonded (covalently) with PAA). Pursuant to an implementation, the polymer coacervate powder is formed by mixing PAA₄₀₀ₖ of 0.1 mM and PEO₁₀₀ₖ of 1 mM in deionized water. A PEO-PAA polymer coacervate complex powder is formed after removal of the supernatant.

The polymer coacervate composition may then be added to contaminated water as a powder, which then forms a polymer dense coacervate phase and a supernatant aqueous solution that is purified with negligible trace of PFAS through spontaneous liquid-liquid separation. Accordingly, the process of removing contaminates from water per FIG. 1 may include adding a predefined amount of pre-made polymer coacervate adsorbent to contaminated water, which may be in the form of a powder or membrane, for example. Pursuant to another example, additionally or alternatively, the two polyelectrolyte compounds, e.g., PAA and PEO, may be added separately at a predefined molar or weight ratio to the contaminated water, in which case the polyelectrolytes spontaneously form the coacervate complex(es) in the contaminated water for treatment. In either process, the obtained supernatant aqueous solution after centrifugation is purified water as qualified by mass spectroscopy. The removal efficiency of PFAS from water is about 99% or down to about 4-10 ppt. The extraction of PFAS occurs spontaneously in water and the supernatant is the treated water.

From the above, an exemplary process for treating contaminated water (e.g., removing PFAS from water) includes adding a polymer coacervate adsorbent comprising oppositely charged polyelectrolytes to contaminated water. The oppositely charged polyelectrolytes may be biocompatible. Pursuant to an implementation, the oppositely charged polyelectrolytes comprise polyacrylic acid (PAA) and/or polyethylene oxide (PEO). The polymer coacervate adsorbent may be a pre-made PEO-PAA coacervate powder prepared by mixing PEO and PAA at predefined weight and molar ratios in an aqueous solution. Alternatively, the polymer coacervate adsorbent may be added by introducing a first powder of PAA and a second powder of PEO to the contaminated water for treatment, wherein the two powders spontaneously form the coacervate complexes in situ or freshly in the contaminated water for removing contaminates.

Perfluorooctanoic acid (PFOA) and perfluoro octane sulfonate (PFOS), two commonly found chemicals in PFAS, in model wastewater can be efficiently extracted from water such as wastewater, according to the disclosure, by the added polymer coacervates upon spontaneous liquid-liquid separation to the polymer dense coacervate phase while the supernatant aqueous solution is purified with negligible trace of PFAS. Stated otherwise, the PFAS are extracted from the contaminated water by liquid-liquid separation with the polymer coacervate adsorbent, thereby forming a polymer dense coacervate phase and a purified supernatant aqueous solution.

The PFAS concentration via polymer coacervate extraction can be reduced to be lower than 4-10 ppt in a short period of time, e.g., less than about one minute. The extraction capacity and efficiency combined with the highly fast extraction speed far surpasses the extraction efficiency of conventional activated carbon adsorbents.

Pursuant to further implementations, the polymer coacervate adsorbent may have a composition shown in TABLE 1 below:

TABLE 1

| Sample | Composition |
|---|---|
| A | PAA₄₅₀ₖ (0.1 mM) + PEO₁₀₀ₖ (1 mM) |
| B | PAA₄₅₀ₖ (0.1 mM) + PEO₁₀₀ₖ (1 mM) |
| C | PAA₄₀₀₀ₖ (0.0025 mM) + PEO₁₀₀ₖ (1 mM) |
| D | PAA₄₀₀₀ₖ (0.0025 mM) + PEO₁₀₀ₖ (1 mM) |
| E | 5 mg freeze-dried powder of Sample A |

The extraction efficiency of the disclosed polymer coacervate adsorbent in Samples A-E of TABLE 1 was tested, with the results shown in FIG. 2. The Samples A-E were prepared in 1 ml PFOA solution, in relation to a reference sample that did not include the adsorbent-Sample A: 10 ml PAA 450 k (0.1 mM)+10 ml PEO 100 k (1 mM)+1 ml PFOA; Sample B: 20 ml PAA₄₅₀ₖ (0.1 mM)+20 ml PEO₁₀₀ₖ (1 mM)+1 mL PFOA; Sample C: 10 ml PAA₄₀₀₀ₖ (0.0025 mM)+10 ml PEO₁₀₀ₖ (1 mM)+1 mL PFOA; Sample D: 20 ml PAA₄₀₀₀ₖ (0.0025 mM)+20 ml PEO 100 k (1 mM)+1 mL PFOA; Sample E: 5 mg freeze-dried powder of Sample A. As FIG. 2 demonstrates, the disclosed polymer coacervate adsorbent as represented by Samples A-E achieves advantages with respect to higher separation speed and better separation efficiency, with experiments demonstrating that the PFAS concentration can be reduced to be lower than about 4-20 ppt in drinkable water in less than 1 minute by adding the polymer coacervate adsorbent to the contaminated water.

From the above, an exemplary polymer coacervate adsorbent for removing contaminates from water (e.g., removing PFAS from contaminated water) includes a polymer coacervate material including oppositely charged polyelectrolytes. The two oppositely charged polyelectrolytes may be biocompatible. The oppositely charged polyelectrolytes may be bonded/linked together, e.g., a polycation covalently bonded with a polyanion. Additionally or alternatively, the polyelectrolytes may include polyacrylic acid (PAA) and/or polyethylene oxide (PEO). The PAA may be PAA₄₀₀ₖ or PAA₄₅₀ₖ or PAA₄₀₀₀ₖ. The PEO may be PEO₁₀₀ₖ. For example, the polyelectrolytes include PAA of 0.1 mM and PEO of 1 mM. As another example, the polyelectrolytes include PAA of 0.0025 mM and PEO of 1 mM.

In addition, as the polymer coacervates of the disclosure have also been shown to efficiently remove cyanotoxin in blue-green algae in fresh water, and accordingly demonstrates dual- or multi-function capabilities such as a separation membrane to remove multiple contaminant species for freshwater treatment.

Thus, disclosed is a spontaneously liquid-liquid separating coacervate complexation process used for multi-specie removal of PFAS and biological toxins for wastewater and/or drinkable water treatment. The polymer coacervate complex material may be pre-made (e.g., two polyelectrolytes bonded together in polymer form) and added then added to the contaminated water, or the two polyelectrolyte compounds may be added separately to the contaminated water (e.g., two polymer compounds can be added at a given concentration ratio) which then forms the polymer coacervate complex material in situ, or freshly made in the aqueous solution (i.e., spontaneously forming/combining in the contaminated water).

The coacervate complex materials may, according to the disclosure, be made into a powder for use directly in mixer-settlers and/or made into a membrane for filtration/separation (e.g., a polymer separation membrane).

According to the disclosure, an adsorbent, composition and method includes a novel type of polymer coacervate adsorbent using two biocompatible oppositely charged polyelectrolytes for the rapid and efficient removal of per- and polyfluoroalkyl substances (PFAS) from contaminated water. Perfluorooctanoic acid (PFOA) and perfluoro octane sulfonate (PFOS) are extracted from water by the added polymer coacervates upon spontaneous liquid-liquid separation to the polymer dense coacervate phase while the supernatant aqueous solution is purified with negligible trace of PFAS.

It is to be understood that the above description is intended to be illustrative and not restrictive. Many applications other than the examples provided would be upon reading the above description. The scope of the disclosure should be determined, not with reference to the above description, but should instead be determined with reference to the appended claims, along with the full scope of equivalents to which such claims are entitled. It is anticipated and intended that future developments will occur in the arts discussed herein, and that the disclosed materials and methods will be incorporated into such future embodiments. In sum, it should be understood that the disclosure is capable of modification and variation and is limited only by the following claims.

When introducing elements of various embodiments of the disclosed materials, the articles “a,” “an,” “the,” and “said” are intended to mean that there are one or more of the elements. The terms “comprising,” “including,” and “having” are intended to be inclusive and mean that there may be additional elements other than the listed elements. Furthermore, any numerical examples in the following discussion are intended to be non-limiting, and thus additional numerical values, ranges, and percentages are within the scope of the disclosed embodiments. It will also be understood that, although the terms first, second, etc. are, in some instances, used herein to describe various elements, these elements should not be limited by these terms. These terms are only used to distinguish one element from another.

While the preceding discussion is generally provided in the context of a material used in connection with water treatment absorbents, it should be appreciated that the present techniques are not limited to such limited contexts. The provision of examples and explanations in such a context is to facilitate explanation by providing instances of implementations and applications. The disclosed approaches may also be utilized in other contexts or configurations.

While the disclosed materials have been described in detail in connection with only a limited number of embodiments, it should be readily understood that the embodiments are not limited to such disclosed embodiments. Rather, that disclosed can be modified to incorporate any number of variations, alterations, substitutions or equivalent arrangements not heretofore described, but which are commensurate with the spirit and scope of the disclosed materials. Additionally, while various embodiments have been described, it is to be understood that disclosed aspects may include only some of the described embodiments. Accordingly, that disclosed is not to be seen as limited by the foregoing description, but is only limited by the scope of the appended claims.

What is claimed is:

1. An adsorbent for removal of per- and polyfluoroalkyl substances (PFAS) from contaminated water, comprising:
a polymer coacervate material including oppositely charged polyelectrolytes.

2. The adsorbent of claim 1, wherein the oppositely charged polyelectrolytes are biocompatible.

3. The adsorbent of claim 1, wherein the oppositely charged polyelectrolytes comprise a polycation covalently bonded with a polyanion.

4. The adsorbent of claim 1, wherein the polyelectrolytes include polyacrylic acid (PAA) and/or polyethylene oxide (PEO).

5. The adsorbent of claim 4, wherein the PAA is PAA₄₀₀ₖ or PAA₄₅₀ₖ or PAA₄₀₀₀ₖ.

6. The adsorbent of claim 4, wherein the PEO is PEO₁₀₀ₖ.

7. The adsorbent of claim 1, wherein the polyelectrolytes include PAA of 0.1 mM and PEO of 1 mM.

8. The adsorbent of claim 1, wherein the polyelectrolytes include PAA of 0.0025 mM and PEO of 1 mM.

9. The adsorbent of claim 1, in the form of a powder or a membrane.

10. A method of removing per- and polyfluoroalkyl substances (PFAS) from water comprising,
adding a polymer coacervate adsorbent comprising oppositely charged polyelectrolytes to contaminated water.

11. The method of claim 10, wherein the oppositely charged polyelectrolytes are biocompatible.

12. The method of claim 10, wherein the oppositely charged polyelectrolytes comprise polyacrylic acid (PAA) and/or polyethylene oxide (PEO).

13. The method of claim 10, further comprising extracting the PFAS from the contaminated water by liquid-liquid separation with the polymer coacervate adsorbent, thereby forming a polymer dense coacervate phase and a purified supernatant aqueous solution.

14. The method of claim 10, wherein the polymer coacervate adsorbent is a pre-made PEO-PAA coacervate powder prepared by mixing 0.1 of PAA and 1 mM of PEO in aqueous solution.

15. The method of claim 14, wherein the PAA is PAA₄₅₀ₖ and the PEO is PEO₁₀₀ₖ.

16. The method of claim 10, wherein the polymer coacervate adsorbent is a pre-made PEO-PAA coacervate powder prepared by mixing 0.0025 mM of PAA and 1 mM of PEO in aqueous solution.

17. The method of claim 16, wherein the PAA is PAA₄₀₀₀ₖ and the PEO is PEO₁₀₀ₖ.

18. The method of claim 10, wherein adding the polymer coacervate adsorbent includes adding a first powder of a polycation and a second powder of a polyanion separately from the first powder of the polycation to the contaminated water.

19. The method of claim 18, wherein the first powder of the polycation includes PEO and the second powder of the polyanion includes PAA.

20. A polymer coacervate composition for treating contaminated water, comprising:
two oppositely charged biocompatible polyelectrolytes.
